(19) United States
(12) Patent Application Publication
(10) Pub. No.: US 2018/0129034 A1
(43) Pub. Date: May 10, 2018

(54) MAGNIFYING AND LIGHTING APPARATUS FOR VIEWING TOENAILS

(71) Applicant: Diane Wilson, Waterbury, CT (US)

(72) Inventor: Diane Wilson, Waterbury, CT (US)

(21) Appl. No.: 15/347,108

(22) Filed: Nov. 9, 2016

(51) Int. Cl. G02B 25/02; A45D 29/00; F21S 8/00; F21V 23/06; G02B 25/00; F21V 14/02; F21V 17/02; F21V 17/08; F21V 17/10; F21V 17/16

(52) U.S. Cl. CPC G02B 25/02; A45D 29/00; F21S 8/03; F21V 23/06; F21V 17/16; F21V 14/02; F21V 17/02; F21V 17/08; F21V 17/108; G02B 25/002

(57) ABSTRACT

Disclosed herein is a foot apparatus comprising a foot or ankle securing device, a magnifying and lighting device, and a flexible connector having a rear end connected to the foot securing device and a front end connected to the magnifying and lighting device.

### TECHNICAL FIELD

Embodiments of the disclosure relate to the field of pedicuring, foot care, and toenail care. More particularly, embodiments of the disclosure relate to a magnifying and lighting device for enhanced viewing of target areas on the foot, such as toes and toenails to aid in pedicuring, foot care, and toenail care.

### BACKGROUND

For women and men across the globe, medical and aesthetic foot care, toe, and toenail care are essential and a regular aspect of personal care. This involves routinely cleaning dirt, soap scum, and dead skin from around the nails and beneath them, clipping and/or filing the nails to a desired length, and attending to medical needs on the foot, toes, and toenails. In the pedicuring industry, the growing popularity of nail art has also expanded the practice of fine details and toenail embellishments. Presently, there is an abundance of tools (nail clippers, cuticle pushers, files, brushes, etc.), nail polishes, nail art supplies, scrubs, lotions, and such for performing maintenance, beautifying, and medical treatments in foot, toe, and toenail care. There is, however, no current means of improved viewing of the small targeted areas on the feet such as the toenails.

### SUMMARY

In some embodiments, the present disclosure is directed to a foot apparatus that provides magnification and lighting to a particular area of interest on the foot, specifically small areas of interest on the foot, such as toes and toenails. The foot apparatus may be secured to the foot, thereby providing for hands free use when aesthetically or medically caring for the foot, toes, and toenails.

The foot apparatus may comprise a foot securing device, a magnifying and lighting device connected to the foot securing device, and a flexible connector for connecting the foot securing device to the magnifying and lighting device.

In some embodiments, the foot apparatus may comprise an ankle securing device comprising one or more fasteners. The foot apparatus may further comprise a magnifying and lighting device connected to the ankle securing device and a flexible connector for connecting the ankle securing device to the magnifying and lighting device.

In other embodiments, the foot apparatus may comprise a foot securing device, one or more mechanical posts attached on either side of the sole, a magnifying and lighting device connected to the foot securing device, and a flexible connector for connecting the foot securing device to the magnifying and lighting device.

The foot securing device in any of the embodiments disclosed herein may comprise a sole shaped to extend along a portion of the bottom of a foot of a user and an upper connected to the sole such that the upper and sole collectively are shaped to receive and/or envelope at least a portion of a heel of a user and in some embodiments the entirety of the heel of the user. In some embodiments, the foot and/or ankle securing device may comprise one or more fasteners to secure the foot securing device to the foot, ankle, heel, etc of the user.

The magnifying and lighting device in any of the embodiments disclosed herein may comprise a housing, a magnifying lens contained in the housing, and one or more guides arranged on the housing to guide direction of the magnifying lens at a target location on a foot of a user and illuminate the target location. In some embodiments, the one or more guides may comprise light emitting diode(s) (LEDs).

The flexible connector in any of the embodiments disclosed herein may have a rear end connected to the foot or ankle securing device and a front end connected to the magnifying and lighting device. The front end of the flexible connector may be coupled to the magnifying and lighting device via a rotatable mechanism to allow flexible rotation of the magnifying and lighting device. The rear end of the flexible connector may be coupled, via a rotatable mechanism, to the sole, the fastener, or mechanical post(s) attached to either side of the foot securing device. The rotatable mechanism coupling the flexible connector to the foot or ankle securing device may allow relocation of the flexible connector to either side of the foot or ankle securing device, thereby accommodating right handed and left handed individuals.

The one or more fasteners in the foot apparatuses disclosed herein may comprise one or more of Velcro, strap, hook and loop fastener, a buckle, a clasp, a clipping mechanism, a snap, a locking ring, frictional force, a zipper, a shoelace, or combinations thereof.

The foot apparatuses disclosed herein may secure different parts of a user's foot including but not limited to the ankle and/or the heel. In some embodiments, securing the user's heel would envelope the user's heel in its entirety. In other embodiments, the user's heel may be full exposed or partially exposed.

### BRIEF DESCRIPTION OF THE DRAWINGS

The above and other features of the present disclosure, their nature, and various advantages will become more apparent upon consideration of the following detailed description, taken in conjunction with the accompanying drawings which are not necessarily drawn to scale and wherein:

FIG. 1 illustrates a side view of an embodiment of the disclosure featuring mechanical posts on either side of the sole;

FIG. 2 illustrates a front view of the embodiment depicted in FIG. 1;

FIG. 3 illustrates a bottom view of an embodiment of the disclosure featuring a relocatable arm coupled to the sole's bottom;

FIG. 4 illustrates a front view of the embodiment depicted in FIG. 3;

FIG. 5 illustrates a side view of an embodiment of the disclosure featuring an ankle securing device;

FIG. 6 illustrates a front view of the embodiments depicted in FIG. 5;

FIG. 7 illustrates a side view of an embodiment of the disclosure featuring a foot securing device exposing a portion of a user's heel;

FIG. 8 illustrates a bottom view of the embodiment depicted in FIG. 7 featuring the magnifying and lighting device connected the foot securing device;

FIG. 9 illustrates a bottom view of the embodiment depicted in FIG. 7 without the magnifying and lighting device;

FIG. 10 illustrates a prospective view of the embodiment depicted in FIG. 7.

### DETAILED DESCRIPTION

Embodiments of the disclosure relate to a magnifying and lighting device attached to a securing device that could secure various parts of the foot, such as the heel and/or the ankle. Magnifying and lighting devices are used to improve visibility of small and difficult-to-see objects and print. More particularly, magnifying and lighting devices on flexible gooseneck with weighted bases, clips, or clamps are available for use in such activities as model painting, needlework, crafts, and for reading. However, the above-described devices are not suitable devices to aid in foot care and toenail care such as in the art of pedicuring. Direct lighting and magnification of the toes, toenails, and other small areas of interest on the foot is quite beneficial whether or not one has diminished eyesight. It may assist when caring for toes, toenails, and small areas of interest on the foot for aesthetic, medical, surgical, and other purposes. Magnification and direct lighting to toes, toenails, and other small areas of interest on the foot is advantageous for medically treating, cleaning, shaping, polishing, and/or embellishing the toenails with artistic designs.

The present disclosure solves these problems and meets the needs in the art. A combination of a magnifying lens with a lighting assembly may be conveniently positioned at a desirable location above any small area of interest, such as the toes and toenails, and secured comfortably at the heel or ankle for hands-free use.

The magnifying and lighting device of embodiments of the disclosure is connected to the securing device via a flexible connector which may be adjusted to illuminate and magnify a particular area of interest, specifically small area of interests on the foot, such as toes and toenails. The flexibility of the connector allows the magnifying and lighting device to be positioned on either side of the securing device for ease of handling and operation for right-handed and left-handed individuals. The magnifying and lighting device is coupled to the securing device such that the user's hands may be free to perform the desired operation on their own foot and/or toes and/or toenails, and/or other location of interest on the foot. Alternatively, a person other than the user may perform the desired operation on the user's foot and/or toes and/or toenails and/or other location of interest on the foot, by adjusting the flexible connector and repositioning the magnifying and lighting device to suit their comfort.

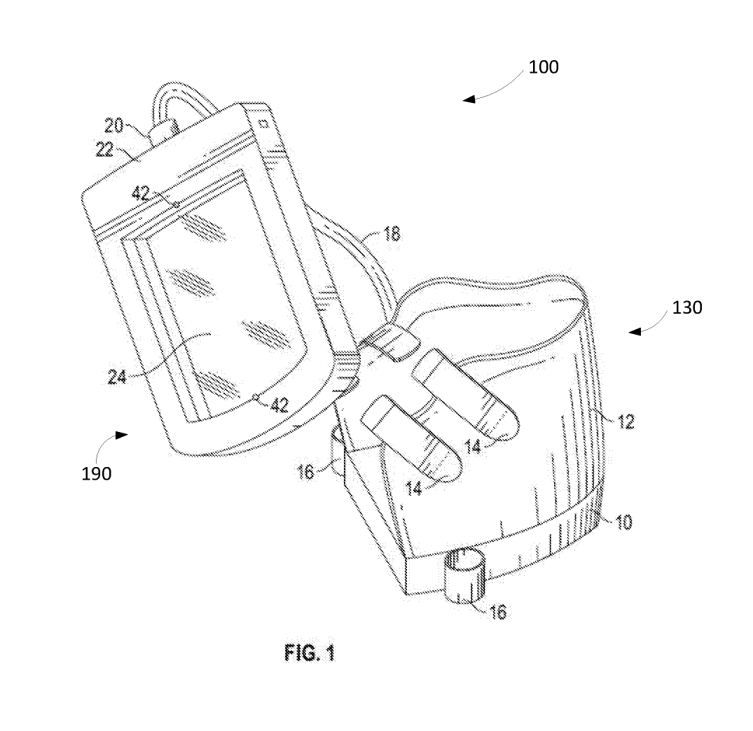

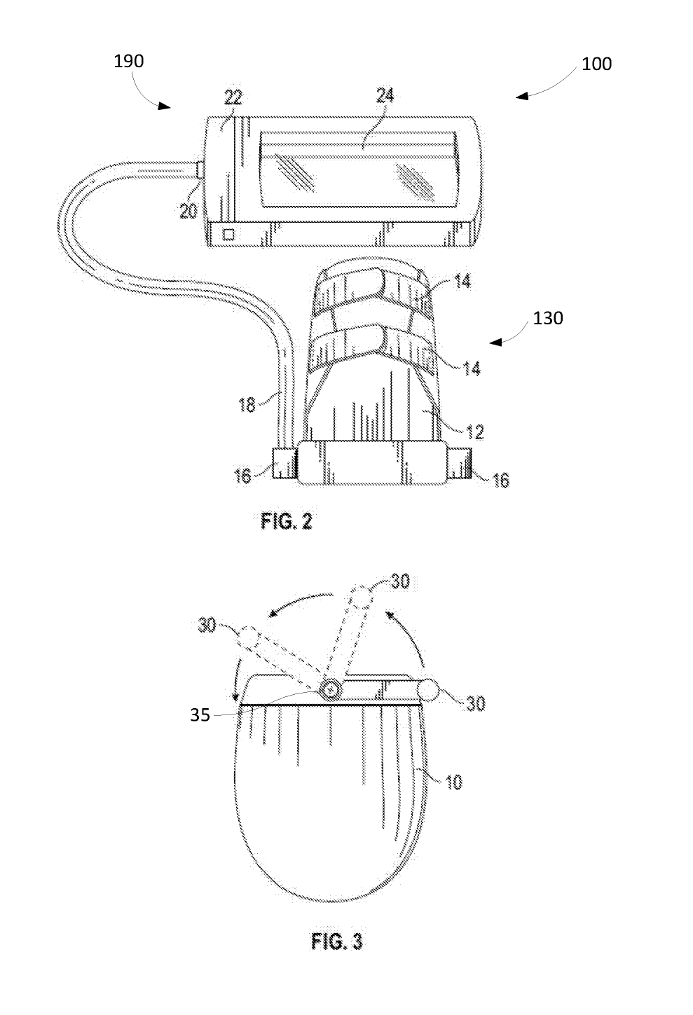

Referring now to the Figures in more detail, FIGS. 1 and 2 illustrate a side view and a front view, respectively, of an embodiment of the disclosure featuring mechanical posts on either side of the sole in the foot securing device. Foot apparatus 100 in FIGS. 1 and 2 comprises a foot securing device 130, a magnifying and lighting device 190, and a flexible connector 18 having a rear end coupled to the foot securing device and a front end coupled to the magnifying and lighting device.

An outer sole 10 extending along a portion of the bottom of a user's foot and upper 12 may be collectively situated at the user's heel and may be adapted to receive the user's heel. Outer sole 10 (also referred to herein as “sole”) extending along a portion of the bottom of a user's foot may be situated for example, under the user's heel, under the middle of the user's foot, under the user's toes, under the entirety of the bottom of the user's foot, or combinations thereof. Upper 12 may have in its inherent design an inner sole upon which the heel of the foot or any other part of the foot rests. Upper 12 may envelope the ankle and heel area in their entirety as illustrated in FIGS. 1 and 2. Alternatively, upper 12 may expose a portion of the ankle, the entire ankle, a portion of the heel, the entire heel, or combinations thereof.

Sole 10 and upper 12 may be made of the same material or of different materials. Both may constructed of a material that is washable and/or waterproof and/or durable and/or sanitary such as rubber. Suitable materials may be neoprene, rubber, fabric, plastic, metal, fur, knit, wood, leather, natural or woven materials, or combinations thereof. The material may have a single color, a combination of colors, a pattern, or a combination of patterns. The material may be elastic, stretchy (particularly the upper), flexible, semi-rigid, or stiff. In some embodiments, sole 10 and upper 12 comprise what will be referenced to at times herein as a “heel shoe.” The heel shoe is an illustration of a foot securing device in accordance with an embodiment of the disclosure. The heel shoe illustrated in FIGS. 1 and 2 may envelop the heel and ankle area in its entirety, ending slightly forward of the heel of the foot.

When foot securing device 130 is secured to the ankle, it provides the foundation and stability for the flexible connector 18 and the benefit of hands free use. Outer sole 10 may have a length that is equal to the length of the flexible connector 18, longer than the flexible connector 18, or shorter than the flexible connector 18. In some embodiments, the outer sole may be about ¾ the length of the flexible connector 18, about ½ the length of the flexible connector, or about ¼ the length of the flexible connector 18. For instance, the sole may have a length ranging from about 1 inches, about 2 inches, about 3 inches, about 4 inches, about 5 inches, about 6 inches to about 7 inches, about 8 inches, about 9 inches, about 10 inches, about 11 inches, or about 12 inches in length.

Sole 10 may have different widths to accommodate individuals with a variety of foot widths. For instance the width of the sole may range from about 1 inches, about 2 inches, about 3 inches to about 4 inches, about 5 inches, or about 6 inches. The thickness of the sole may also vary. For instance, the thickness of the sole may range from about 0.25 inches, about 0.5 inches, about 0.75 inches, to about 1 inch, about 1.25 inches, or about 1.5 inches. From the bottom view, sole 10 may have horseshoe shape. In some embodiments, upper 12 may have an inner sole as part of its design, and the inner sole may be bonded to outer sole 10. Inner sole of upper 12 may be configured to receive a specific part of the foot it is intended to hold and/or envelope.

The foot securing device may further comprise one or more fastener mechanisms (also referred to herein as “fasteners”). The one or more fastener mechanisms may comprise one or more of button, lock, magnet, ring, screw, rivet, eyelet, lace, rope, string, cord, belt, chain, slide, gate ring, silicone adhesive, seam, Velcro, strap, hook and loop fastener, a buckle, a clasp, a clipping mechanism, a snap, a locking ring, frictional force, a zipper, a shoelace, a strap, or combinations thereof. For instance, in FIGS. 1 and 2, the fasteners are Velcro strap(s) 14 which envelope around the ankle and may be used to further secure the user's foot in place.

In an embodiment, sole 10 may be attached to one, two, or more mechanical posts 16 located on either side, or on both sides of the sole 10. The mechanical posts may be positioned anywhere along the sole 10, towards the back of the sole 10, the middle of the sole 10, the front of the sole 10, or combinations thereof. Posts 16 may form housings for flexible connector 18. Flexible connector 18 may have a rear end which may be a threaded into the housing formed by post 16. The plurality of mechanical posts allow a user to select the desired location to thread flexible connector 18 to take full advantage of the magnifying, illuminating, and convenience features (accustomed to a user's right-handed or left-handed preference) of foot apparatus 100.

Mechanical post(s) 16 on either side of outer sole 10 and post 20 are the connecting locales for a length of flexible connector 18. Flexible connector 18 may be any connector that can be flexibly adjusted to a desired position while remaining sufficiently rigid to stay in place when the desired position is reached. Non-limiting examples of flexible connector 18 include a flexible gooseneck, rigid arms, or tubes made of for example, metals or plastics. Flexible connector 18 comprises a front end which may be threaded into a housing formed by post 20, thereby connecting the magnifying and lighting device 190 to the foot or ankle securing device 130. In some embodiments, the front end of flexible connector 18 may be rotatably coupled to the magnifying and lighting device 190 to allow for flexible rotation of the magnifying and lighting device 190.

Flexible connector 18 may have a fixed or an adjustable length. Its length may range for example, from about 1 inches, about 2 inches, about 3 inches, about 4 inches, about 5 inches, about 6 inches to about 7 inches, about 8 inches, about 9 inches, about 10 inches, about 11 inches, or about 12 inches in length. The diameter of the connector may also be fixed or adjustable. The diameter may range from about 0.05 inches, about 0.1 inches, about 0.15 inches, about 0.2 inches to about 0.25 inches, about 0.3 inches, about 0.35 inches, about 0.4 inches, about 0.45 inches, or about 0.5 inches.

Magnifying and lighting device 190 comprises a housing 22, a magnifying lens 24 contained within the housing, and one or more guides (not shown) arranged on the housing to guide placement of the magnifying lens 24 on a target location on a user's foot and illuminate the target location.

Magnifying lens 24 may be a plastic, acrylic, or glass magnifying lens, such as a Fresnel lens. The magnifying lens may have any shape including but not limited to, rectangle, square, circle, oval, triangle, trapezium, diamond, rhombus, parallelogram, pentagon, hexagon, heptagon, octagon, nonagon, decagon, heart, star, or any other conceivable shape. For instance, a rectangular magnifying lens may have a size measuring approximately 2 inches by 4 inches for viewing several toes at once without frequent repositioning. The size may be smaller or larger depending on the desired use of the foot apparatus and/or on the target location on the foot to be magnified. The magnification of the lens may range from about 1.25×, about 1.3×, about 1.4×, about 1.5×, about 1.6×, about 1.7×, about 1.8×, about 1.9× to about 2×, about 2.25×, about 2.5×, about 2.75×, or about 3×.

The one or more guides may comprise light emitting diodes (LEDs) or other illuminating device that would offer additional viewing benefit. The one or more guides may be powered by standard alkaline batteries, rechargeable batteries, or may be connected to a direct power supply (not shown in the figures). The housing may comprise 1, 2, 3, 4, 5, 6, 7, 8, 9, 10 etc guides. The guides may be arranged on one end of the housing 22, on opposite ends of the housing 22, on the circumference of the housing 22, on one end of the magnifying lens 24, on opposite ends of the magnifying lens 24, or on the circumference of the magnifying lens 24. In some embodiments, the guides may be positioned at equal distances from the center of the magnifying lens 24. It is understood that the light emitted from the guides will be directed at the target area of interest, such as the toes or toenails, in order to illuminate that particular area. The guides may be arranged on the upper side of the magnifying lens 24 (i.e. the side further away from the foot) or on the lower side of the magnifying lens 24 (i.e. the side closer to the foot).

FIG. 3 illustrates a bottom view of an embodiment of the disclosure featuring a relocatable arm 30 coupled to the sole's bottom 10. Relocatable arm 30 may have a rear end coupled to sole 10 via a rotatable mechanism 35 to allow relocation of the flexible connector to either side of the foot securing device, and thereby allow for positioning of the magnifying and lighting assembly on either side of the foot securing device. Relocatable arm 30 may be an inseparable part of the flexible connector. Alternatively, relocatable arm 30 may form a housing into which the rear end of the flexible connector may be connected, threaded, attached, or inserted. Rotatable mechanism 35 may be centrally located on the bottom of sole 10, i.e. in an equal distance from either side of the sole, allowing the arm to be positioned on either side of the sole and be held in place by a support bracket, clip, clamp, or other support mechanism (not shown in the figures) on either side. The rotatable mechanism may be positioned in the center from either side and closer to the front of the sole (i.e. the direction of the toes), closer to the back of the sole (i.e. the direction of the heel), or in the center at an equal distance from the front and the back of the sole.

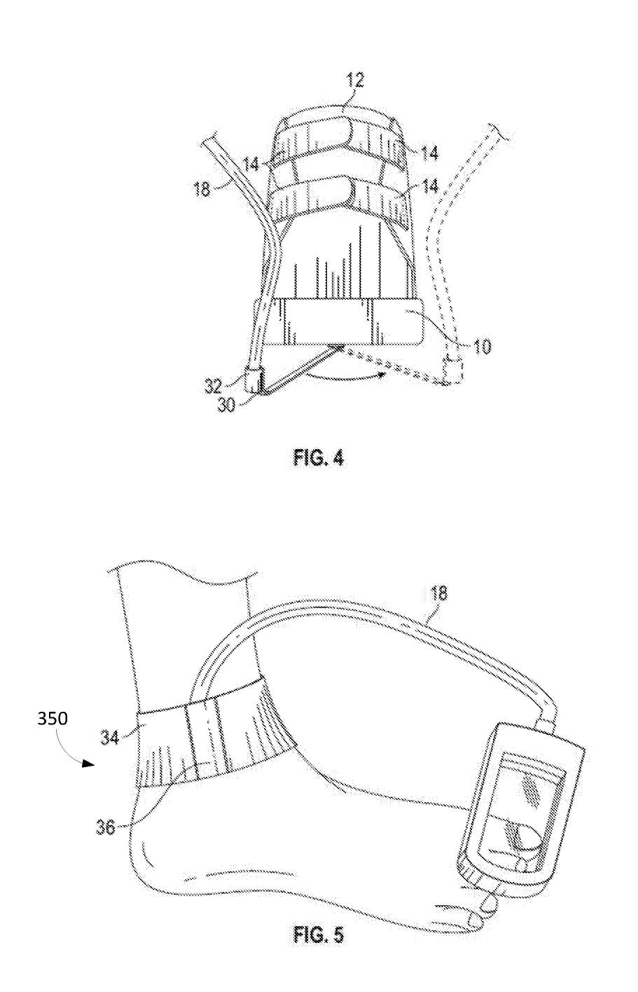

FIG. 4 illustrates a front view of the embodiment depicted in FIG. 3 with relocatable arm 30 connected via a rotatable mechanism (not shown in FIG. 4) to sole 10. Relocatable arm 30 in FIG. 4 having a housing 32 at its front end. Housing 32 in arm 30 is configured to accept the rear end of flexible connector 18.

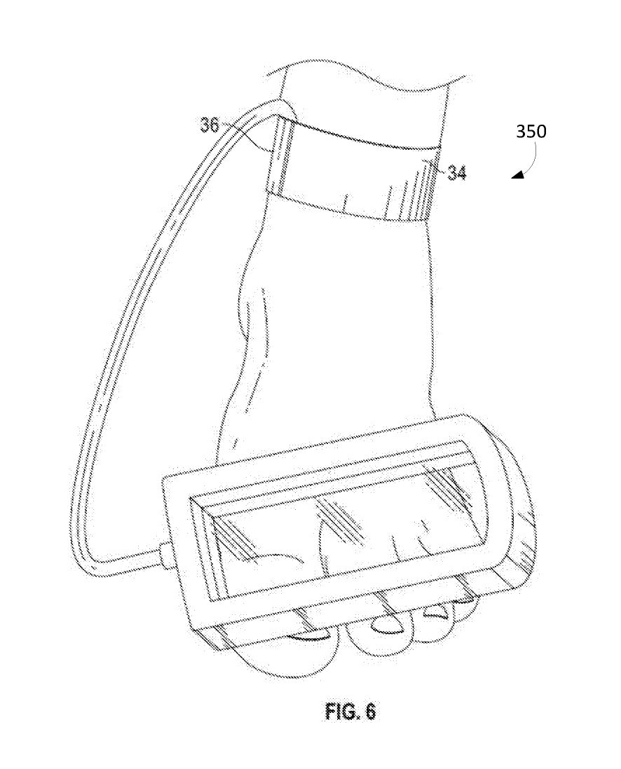

FIG. 5 illustrates a side view of an embodiment of the disclosure featuring an ankle securing device 350. Ankle securing device 350 comprises one or more fastener mechanisms 34 such as button, lock, magnet, ring, screw, rivet, eyelet, lace, rope, string, cord, belt, chain, slide, gate ring, silicone adhesive, seam, Velcro, strap, hook and loop fastener, a buckle, a clasp, a clipping mechanism, a snap, a locking ring, frictional force, a zipper, a shoelace, a strap, or combinations thereof. The ankle securing device 350 may also comprise a housing 36 adapted to accept the rear end of flexible connector 18 which connects the ankle securing device to the magnifying and lighting device. Housing 36 may be a mechanical insert connected to the fastener (for example, sewn to a strap fastener) and can provide stable support for extending flexible connector 18 which is connected to the magnifying and lighting device through its front end. FIG. 6 illustrates a front view of the embodiment depicted in FIG. 5.

The embodiment illustrated in FIG. 5 may also be referred to herein as a “strap design”. Fastener 34 may be a Velcro strap having variable length to accommodate a plurality of ankle widths. For instance, the strap may have a length ranging from about 8 inches, about 9 inches, about 10 inches, about 11 inches, about 12 inches, about 13 inches to about 14 inches, about 15 inches, about 16 inches, about 17 inches, about 18 inches, about 19 inches, or about 20 inches. The width of the strap may range from about 0.5 inch, 1 inch, 1.5 inches, 2 inches to about 3 inches, 4 inches, 5 inches, or 6 inches. The strap can be wrapped around the ankle and/or lower portion of the leg, and may be comfortably secured.

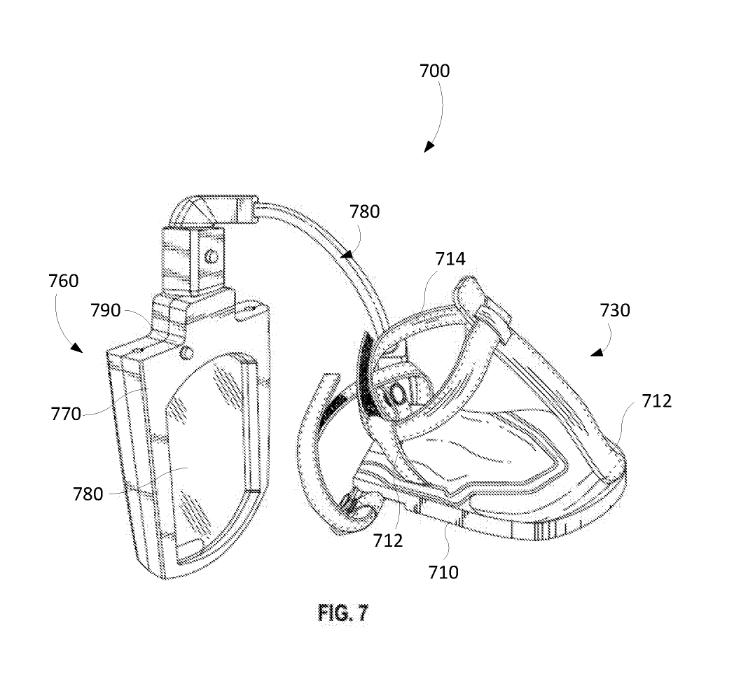

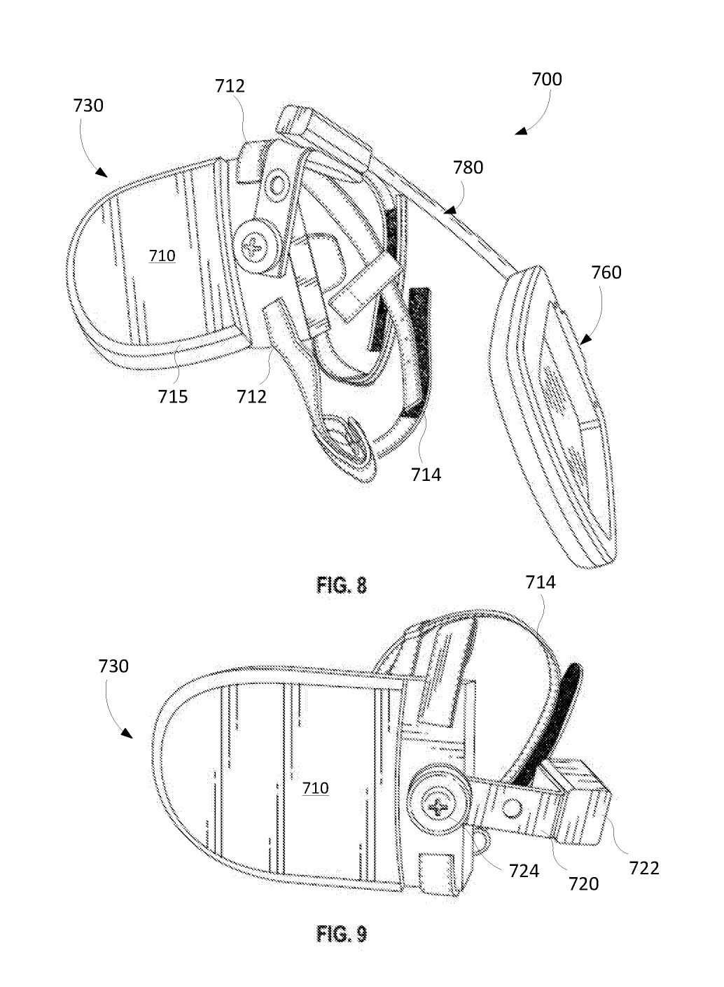

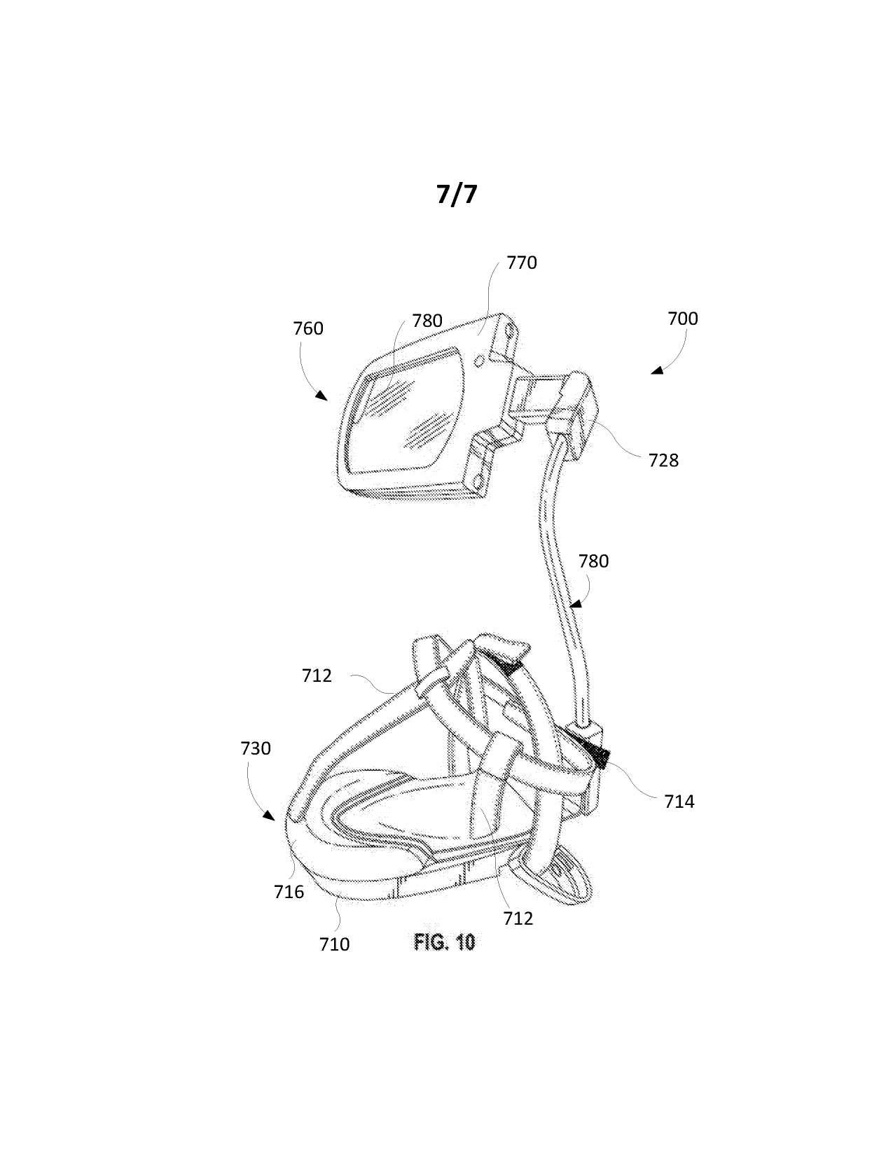

FIG. 7 illustrates a side view of a foot apparatus 700 according to an embodiment of the disclosure. FIG. 8 illustrates a bottom view of the embodiment depicted in FIG. 7 featuring the magnifying and lighting device connected to the foot securing device. FIG. 9 illustrates a bottom view of the embodiment depicted in FIG. 7 featuring a relocatable arm to receive a flexible connector and to become connected to a magnifying and lighting device. The embodiment in FIG. 9 does not include the flexible connector or the magnifying and lighting device. FIG. 10 illustrates a prospective view of the embodiment depicted in FIG. 7.

FIGS. 7 through 10 will be discussed together in further detail below. Foot apparatus 700 features a foot securing device 730 adapted to secure a user's heel while exposing a portion of the user's heel. Foot apparatus 700 may further feature a magnifying and lighting device 760. The lighting the magnifying device 760 may be connected to the front end of a flexible connector 780, and the foot securing device 730 may be connected to the rear end of the flexible connector 780.

The foot securing device 730 may comprise a sole 710 capable of extending along a portion of the bottom of a user's foot. While FIGS. 7 through 10 illustrate a sole 710 capable of extending along the bottom of a user's heel, such configuration should not be construed as limiting. Sole 710 may extend along any portion of the bottom of the user's foot including, but not limited to, the heel, the middle section, the front section underneath the toes, or combinations thereof. The sole may be connected to a bottom heel 715. The heel may be flat and have a thickness of up to about 0.5 inches, for instance, about 0.1 inch, about 0.15 inch, about 0.2 inch, about 0.25 inch, about 0.3 inch, about 0.35 inch, about 0.4 inch, about 0.45 inch, or about 0.5 inch. In some embodiments, there may not be a heel at all. The sole may further comprise an upper sole portion 716 (shown in FIG. 10) configured receive a user's heel.

The foot securing device may further comprise an upper 712 connected to sole 710. In FIGS. 7 through 10, upper 712 comprises a plurality of straps configured to envelope the user's heel. Some of the straps in upper 712 being connected to the bottom front of sole 710, some straps connected to the top front of sole 710, and at least one strap connected to the top rear of sole 710. The plurality of straps connected to the sole being connected among themselves through one or more fasteners 714. The one or more fasteners 714 in FIGS. 7 through 10 being Velcro straps. The strap arrangement of upper 712 should not be construed as limiting. Any upper 712 able to, along with sole 710, hold the user's foot (user's heel, middle portion of foot, front portion of foot, or combinations thereof) can be suitable as a foot securing device 730. The one or more fasteners 714 used to further secure the foot in place also should not be limited to Velcro straps and may be any other suitable fastening mechanism, such as, a button, a lock, a magnet, a ring, a screw, a rivet, an eyelet, a lace, a rope, a string, a cord, a belt, a chain, a slide, a gate ring, a silicone adhesive, a seam, a Velcro, a strap, a hook and loop fastener, a buckle, a clasp, a clipping mechanism, a snap, a locking ring, a frictional force, a zipper, a shoelace, a strap, or combinations thereof.

Sole 710 of the foot securing device may be further connected through a rotational mechanism 724 to an arm 720 (FIG. 9). Arm 720 may comprise a housing 722 adapted to receive the rear end of a flexible connector 780. In some embodiments, arm 720 may be inseparable from foot securing device 730. In other embodiments, arm 720 may be separate from foot securing device 730 and the two may be readily assembled together as needed. In some embodiments, flexible connector 780 may be inseparable from arm 720 and housing 722, while in other embodiments, the two may be separate and may be readily assembled together as needed. It is possible to adjust the position of arm 720 and consequently flexible connector 780 and magnifying and lighting device 760 via rotational mechanism 724. Adjusting the position renders convenient access to the foot by both—right handed and left handed individuals.

Flexible connector 780 may be connected to magnifying and lighting device 760 through housing 728 adapted to receive the front end of flexible connector 780. In some embodiments, flexible connector 780 may be rotatably connected to magnifying and lighting device 760.

Magnifying and lighting device 760 comprises a housing 770, a magnifying lens 780 contained within the housing 770, and one or more guides not shown in the figures (such as LEDs) arranged on the housing to guide placement of the magnifying lens at a target location on the user's foot and illuminate the target location. The housing 770 may further comprise one or more power buttons 790 to activate the one or more guides.

The various dimensions, materials of construction, shapes, magnifications and other details discussed above, directed to the foot securing device and/or flexible connector and/or magnifying and lighting device, are understood to be applicable for the various embodiments of the disclosure, including the embodiment illustrated in FIGS. 7 through 10.

The advantages of the present disclosure include, without limitation, the magnification and direction of light to a target area of interest to aid in foot, toe, and toenail care whether for pedicuring, aesthetic, or medical purposes. The device is one size fits most, is neutral for left or right foot, relocatable for left or right-handed use, and suitable for hands-free use. The magnifying lens may be of any conceivable shape, allowing for viewing the targeted location on the user's foot without frequent repositioning.

The use of the terms “a,” “an,” “the,” and similar referents in the context of describing the materials and methods discussed herein (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the materials and methods and does not pose a limitation on the scope unless otherwise claimed. No language in the specification should be construed as indicating any non-claimed element as essential to the practice of the disclosed materials and methods.

Reference throughout this specification to “one embodiment,” “certain embodiments,” “one or more embodiments” or “an embodiment” means that a particular feature, structure, material, or characteristic described in connection with the embodiment is included in at least one embodiment of the present disclosure. Thus, the appearances of the phrases such as “in one or more embodiments,” “in certain embodiments,” “in some embodiments,” “in one embodiment,” or “in an embodiment” in various places throughout this specification are not necessarily referring to the same embodiment of the present disclosure. Furthermore, the particular features, structures, materials, or characteristics may be combined in any suitable manner in one or more embodiments.

Although the embodiments disclosed herein have been described with reference to particular embodiments it is to be understood that these embodiments are merely illustrative of the principles and applications of the present disclosure. It will be apparent to those skilled in the art that various modifications and variations can be made to the method and apparatus of the present disclosure without departing from the spirit and scope of the disclosure. Thus, it is intended that the present disclosure include modifications and variations that are within the scope of the appended claims and their equivalents, and the above-described embodiments are presented for purposes of illustration and not of limitation.

What is claimed is:

1. A foot apparatus comprising:
a foot securing device;
a magnifying and lighting device connected to the foot securing device; and
a flexible connector for connecting the foot securing device to the magnifying and lighting device, the flexible connector having a rear end connected to the foot securing device and a front end connected to the magnifying and lighting device.

2. The foot apparatus of claim 1, wherein the foot securing device comprises:
a sole shaped to extend along a portion of a foot of a user; and
an upper connected to the sole;
the upper and the sole collectively shaped to receive a heel of the user.

3. The foot apparatus of claim 1, wherein the magnifying and lighting device comprises:
a housing;
a magnifying lens contained within the housing; and
one or more guides arranged on the housing to guide direction of the magnifying lens at a target location on a foot of a user and illuminate the target location.

4. The foot apparatus of claim 2, wherein a rear end of the flexible connector is coupled to the sole via a rotatable mechanism to allow relocation of the flexible connector to either side of the foot securing device.

5. The foot apparatus of claim 2, wherein a front end of the flexible connector is coupled to the magnifying and lighting device via a rotatable mechanism to allow flexible rotation of the magnifying and lighting device.

6. The foot apparatus of claim 2, wherein the foot securing device further comprises one or more fasteners to further secure the foot securing device to the heel of the user.

7. The foot apparatus of claim 3, wherein the one or more guides comprise light emitting diodes.

8. The foot apparatus of claim 6, wherein the one or more fasteners comprise one or more of Velcro, strap, hook and loop fastener, a buckle, a clasp, a clipping mechanism, a snap, a locking ring, frictional force, a zipper, a shoelace, or combinations thereof.

9. The foot apparatus of claim 2, wherein the upper and the sole collectively envelope the heel of the user in its entirety.

10. The foot apparatus of claim 2, wherein the upper and the sole collectively envelope a portion the heel of the user, leaving a portion of the heel exposed.

11. A foot apparatus comprising:
an ankle securing device comprising one or more fasteners;
a magnifying and lighting device connected to the ankle securing device; and
a flexible connector for connecting the ankle securing device to the magnifying and lighting device, the flexible connector having a rear end connected to the ankle securing device and a front end connected to the magnifying and lighting device.

12. The foot apparatus of claim 11, wherein the one or more fasteners envelopes the ankle securing device around a lower portion of a leg of a user, leaving a heel of the user exposed, the one or more fasteners comprising one or more of Velcro, strap, hook and loop fastener, a buckle, a clasp, a clipping mechanism, a snap, a locking ring, frictional force, a zipper, a shoelace, or combinations thereof.

13. The foot apparatus of claim 11, wherein the magnifying and lighting device comprise:
a housing;
a magnifying lens contained within the housing; and
one or more guides arranged on the housing to guide direction of the magnifying lens at a target location on a foot of a user and illuminate the target location.

14. The foot apparatus of claim 11, wherein the front end of the flexible connector is coupled to the magnifying and lighting device via a rotatable mechanism to allow rotation of the magnifying and lighting device.

15. The foot apparatus of claim 13, wherein the one or more guides comprise light emitting diodes.

16. A foot apparatus comprising:
a foot securing device comprising:
a sole shaped to extend along a portion of a bottom of a foot of a user; and
an upper connected to the sole;
the upper and the sole collectively are shaped to receive at least a portion of a heel of a user;
one or more mechanical posts attached on either side of the sole;
a magnifying and lighting device connected to the foot securing device; and
a flexible connector for connecting the foot securing device to the magnifying and lighting device, the flexible connector having a front end connected to the magnifying and lighting device and a rear end secured in the one or more mechanical posts.

17. The foot apparatus of claim 16, wherein the magnifying and lighting device comprises:
a housing;
a magnifying lens contained within the housing; and
one or more guides arranged on the housing to guide direction of the magnifying lens at a target location on a foot of a user and illuminate the target location, the one or more guides comprise light emitting diodes.

18. The foot apparatus of claim 16, wherein the front end of the flexible connector is coupled to the magnifying and lighting device via a rotatable mechanism to allow flexible rotation of the magnifying and lighting device.

19. The foot apparatus of claim 16, wherein the foot securing device further comprises fasteners to further secure the foot securing device to a heel of the user, the fasteners comprise one or more of Velcro, strap, hook and loop fastener, a buckle, a clasp, a clipping mechanism, a snap, a locking ring, frictional force, a zipper, a shoelace, or combinations thereof.

20. The foot apparatus of claim 16, wherein the upper and sole collectively envelope a heel of the user in its entirety.
